(19) United States
(12) Patent Application Publication
(10) Pub. No.: US 2003/0000809 A1
(43) Pub. Date: Jan. 2, 2003

(54) Automatic spacing gravity feed system

(76) Inventors: Timothy Stanley Sieczka, Ann Arbor, MI (US); Scott Paul Bethke, Howell, MI (US)

Correspondence Address: INNO-VEYOR, INC., 12502 GLOBE ROAD, LIVONIA, MI, 48150, US

(21) Appl. No.: 09/895,683

(22) Filed: Jul. 2, 2001

(51) Int. Cl. B65G 47/04

(52) U.S. Cl. 198/562

(57) ABSTRACT

A gravity feed system comprised of rails with a specially designed “multi-spoke wheel” for use in the automatic spacing of cylindrical (and other shaped) parts to be conveyed. The rails are an item that can be purchased commercially or manufactured for various needs. The “multi-spoke wheel” is an item that is specifically designed for a part or family of parts with similar geometry. The size of the star, along with the centerline to centerline spacing and vertical placement of the rotating axis below the part is the critical feature. A part is loaded onto the rails and feeds by gravity through the “multi-spoke wheels” ending at a hard stop. When other parts are loaded they also feed by gravity to the stop end and are spaced out by the “multi-spoke wheels”. When the last part is unloaded from the rails by pulling it out, the remaining parts still on the rails feed the distance of one part. While in transit, the parts will stay spaced out by use of the “multi-spoke wheel”. The spokes of the wheels will feed up between parts as they proceed forward down the rails thus maintaining a set spacing.

### BACKGROUND OF THE INVENTION

1. Field of Invention

This invention concerns gravity feed systems that would normally just let a part roll or slide down on rails, rollers, or a flat pan by means of gravity to a specific point. This metering conveyor will consist of specially designed multi-spoke wheels on shafts that will spin freely, supported between transfer rails, and that will meter the product to be conveyed and keep them evenly spaced.

2. Description of Prior Art

This invention concerns gravity feed systems that would normally just let a part roll down on rails or a flat pan of some sort to a specific point. In the past these systems would just let parts bang into one another thereby creating noise and possibly damage to the product. In addition, the rolling friction of one part relative to an adjacent part creates friction that has to be overcome to allow parts to transfer. The usefulness of this invention is to prevent parts from making contact with one another. It is particularly useful when conveying parts that are coated in a non-slip product (such as rubber) and parts that have specific geometry that prevents them from butting up to one another evenly. With the prior systems in operation today, there could be a potential pinch-point between parts either during unload due to the parts resting against one another or by parts making contact with one another during transit. This invention also allows for constant space between parts thereby preventing a pinch-point.

### BRIEF SUMMARY OF THE INVENTION

A gravity feed system comprised of specially designed multi-spoke wheels on shafts that spin freely and are supported between transfer rails. These multi-spoke wheels will meter the product to be conveyed while keeping them evenly spaced. The usefulness of this invention is to prevent the product to be conveyed from making contact with one another. It is particularly useful when conveying cylindrical parts that are coated in a non-slip product (such as rubber) and parts that have specific geometry that prevents them from butting up to one another evenly. Conveying other shapes or geometry may be accommodated by means of rollers on the rails to allow for gravity feed by the reduction of friction. This invention provides solutions for noise abatement, product damage, and pinch point conditions.

### BRIEF DESCRIPTION OF THE SEVERAL VIEWS OF THE DRAWING

FIG. 1: Plan View of the Overall Unit—showing multi-spoke wheel spacing, orientation, and the product spacing achieved

FIG. 2: Elevation View of the Overall Unit—showing multi-spoke wheel profile, spacing of multi-spoke wheel, hard stop, and basic frame

FIG. 3: End View of the Overall Unit—showing shaft of rotation, multi-spoke wheel spacing, bearing block, typical product, and basic frame

FIG. 4: Detail of Multi-spoke wheel—showing multi-spoke with rollers around perimeter

### DETAILED DESCRIPTION OF THE INVENTION

In the following detailed description, certain specific terminology will be employed for the sake of clarity and a particular embodiment in accordance of 35 USC 112, but it is understood that the same is not intended to be limiting and should not be so construed inasmuch as the invention is capable of taking on many forms and variations within the scope of the appended claims.

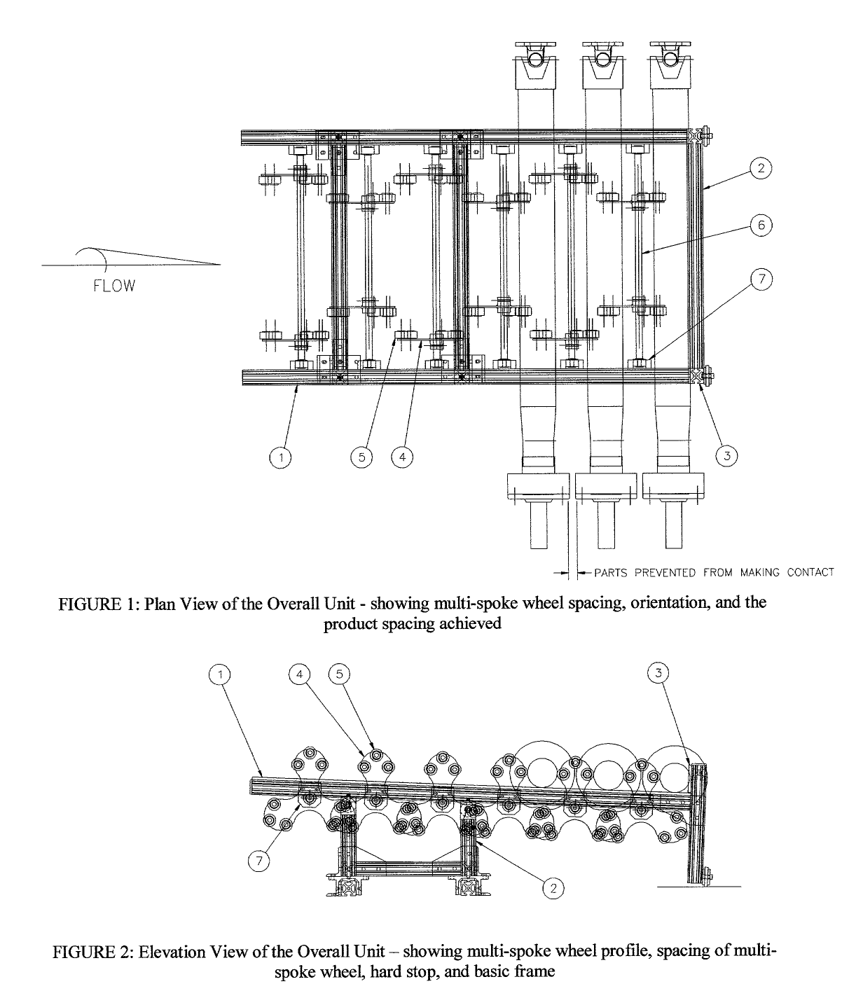

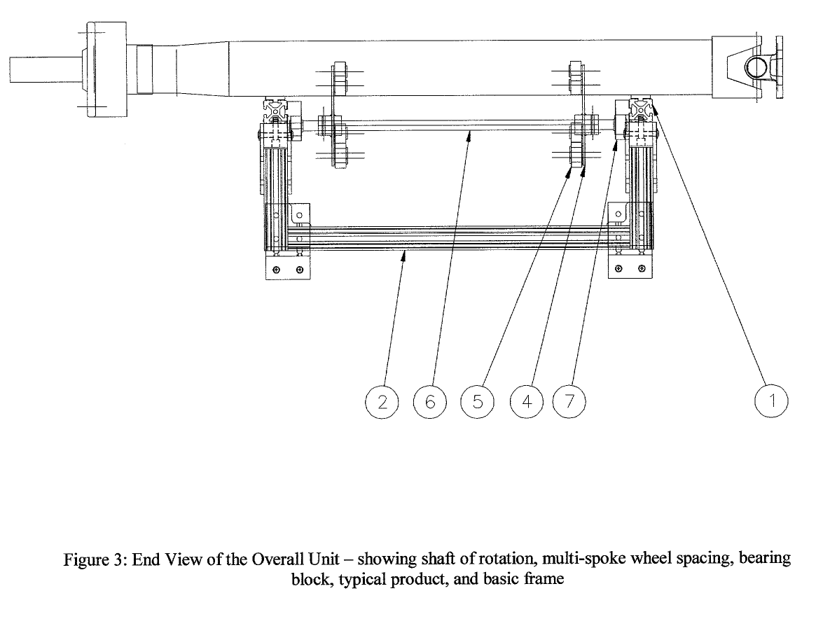

Referring to the drawings, FIGS. 1 through 4 illustrate a gravity metering system which includes (1) transfer rails, (2) basic frame structure, (3) a hard stop, (4) the multi-spoke wheel, (5) roller bearing on multi-spoke wheel, (6) multi-spoke wheel connecting and rotation shaft, and (7) shaft bearing and block.

The basic operation of the gravity metering device is that when a part is loaded on to the end of the rails (1), it will roll down by means of gravity through the multi-spoke wheels (4) causing them to spin freely, until it reaches the hard stop (3). When additional parts are loaded onto the rails (1), they will also roll down by means of gravity through multi-spoke wheels (4), until it reaches the previous part in rest position and it contacts the multi-spoke wheel (4) and rollers (5) that is upright between the parts (see FIG. 2).

The basic operation of the gravity metering device when a part is unloaded from the end of the rails (1) at the hard stop (3), is that the remaining parts on the rails (1) will advance a distance of one part width. When the parts are in motion, the multi-spoke wheel (4) will rotate freely and one of the spokes will move up and in between two adjacent parts thereby maintaining the correct spacing at all times.

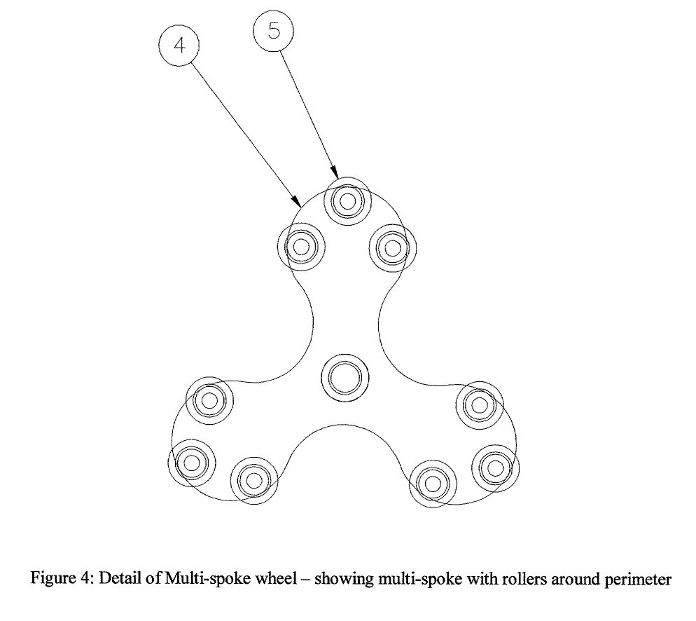

The profile of multi-spoke wheel (4), detail shown in FIG. 4, is designed so as to maintain a specified distance between adjacent parts. Also the pitch, or distance between the multi-spoke wheel shafts (6), is set to allow each multi-spoke wheel (4) to spin and follow in behind the part that is leaving.

What is claimed:

1. A part transfer unit that automatically spaces parts of like geometry (cylindrical or other shapes) and transports them by means of gravity only, providing solutions for noise abatement, product damage, pinch-point conditions, and parts that would normally not transfer when resting against one another (i.e. non-slip surface).

2. A method of designing a multi-spoke wheel based on the geometry(size) of the part to be conveyed, and the desired spacing between parts.

3. A method of designing the placement of the shafted multi-spoke wheels based on the geometry(size) of the part to be conveyed, and the desired spacing between parts. This refers to the center to center distance of multi-spoke wheels and the location of axis of revolution of the shafts relative to the transfer rail. This spacing and orientation relative to the transfer rails will achieve the constant distance between each product to be conveyed when they are at rest and also maintain that distance between parts while they are in motion. This configuration allows for a spoke of the shafted multi-spoke wheel to follow a part in motion and feed up between to adjacent parts.

4. The addition of perimeter rollers on the above multi-spoke wheel to allow for parts with non-slip characteristics (i.e. rubberized) to roll freely against the spinning multi-spoke wheel.
